(19) United States
(12) Patent Application Publication
(10) Pub. No.: US 2007/0291747 A1
(43) Pub. Date: Dec. 20, 2007

(54) Method and system for user to user targeted advertising

(76) Inventors: Benjamin J. Stern, Morris Township, NJ (US); Ganesh K. Subramaniam, Bridgewater, NJ (US)

Correspondence Address: AT&T CORP., ROOM 2A207, ONE AT&T WAY, BEDMINSTER, NJ, 07921, US

(21) Appl. No.: 11/455,561

(22) Filed: Jun. 19, 2006

(51) Int. Cl. H04L 12/66

(52) U.S. Cl. 370/356

(57) ABSTRACT

A method and system for user to user targeted advertising using a digital television delivery service, such as Internet Protocol Television (IPTV) or digital cable. Content is received and delivery information is specified via an IP network. The content is then delivered as advertising content based on the delivery information to at least one targeted user as part of a digital data stream. The advertising content and delivery information can be input by a user through a web interface.

### BACKGROUND OF THE INVENTION

The present invention is directed to targeted television advertising. More specifically, the present invention is directed to subscriber to subscriber advertising using a digital television delivery system, such as Internet Protocol Television (IPTV), digital cable, or the like.

IPTV is a service in which television programming is delivered to consumers via a data network (e.g., the Internet) using Internet Protocol. More particularly, in IPTV, television programming is delivered as video content, which is divided into data packets and streamed to consumers over the Internet. The IPTV stream of data packets is received by an IPTV client device, such as a set top box, which is connected to a subscriber's television. Typically, IPTV client devices connect to the Internet over a broadband connection.

IPTV provides greater control and flexibility to consumers than traditional TV distribution technologies. For example, because television programming is delivered point-to-point from a provider to a subscriber (“user”), a user may individually control (i.e., pause, rewind, etc.) programming being delivered. Also, because television programming is being delivered over the Internet, a user may receive IPTV programming from around the world.

In various other digital television delivery systems, such as digital cable and satellite, digital data streams are delivered to a set top box, which is connected to a user's television. These digital television delivery systems can provide various levels of control and flexibility to users.

IPTV, and other digital television delivery systems, offer greater control to service providers than traditional TV distribution technologies. Because of this greater control, service providers can provide personalized TV advertising. That is, service providers can target specific users or groups of users with customized advertisements based on viewing or purchasing habits of the users. Furthermore, in order to make television advertising into a more democratic medium, it is desirable to allow users to easily create advertisements and target the advertisements to another individual user or group of users

### BRIEF SUMMARY OF THE INVENTION

The present invention provides a service which allows users of Internet Protocol Television (IPTV), or other digital television delivery systems, to create advertisements and target the advertisements to other users.

In one embodiment of the present invention, advertising content and delivery information is received via an IP network. The advertising content and the delivery information can be input by a user via a web interface. The delivery information specifies at least one targeted IPTV user. The advertising content is then delivered to at least one specified IPTV user as part of an IPTV stream. The advertising content may be delivered to the targeted user during a commercial break in IPTV programming or on a dedicated IPTV channel. The delivery of advertising content may be verified when received by the targeted user.

In another embodiment of the present invention, advertisement information and delivery information is received from a first IPTV client device, and an advertisement is created based on the advertisement information. The advertisement information corresponds to desired characteristics of the advertisement and can include the selection of an advertisement template, which is customized and stored. The created advertisement is delivered to a second IPTV client device as part of an IPTV stream.

These and other advantages of the invention will be apparent to those of ordinary skill in the art by reference to the following detailed description and the accompanying drawings.

### BRIEF DESCRIPTION OF THE DRAWINGS

FIG. 1 illustrates a method of user to user advertising using Internet Protocol Television (IPTV) according to an embodiment of the present invention; and

FIG. 2 illustrates a high level block diagram of a computer capable of implementing the present invention.

### DETAILED DESCRIPTION

In accordance with the present invention, users of a digital television delivery service, can create customized advertisements and target the advertisements to other users of the digital television delivery service. As used herein, the term “user” refers to a subscriber, customer, or viewer of the digital television delivery service. A digital television delivery service is any service in which television programming is transmitted to a user device in the form of a digital data stream. The digital data stream is addressable to individual user devices, such as set top boxes. For example, the digital data stream can transmit television programming in the form of addressable data packets. Examples of digital television services include Internet Protocol Television (IPTV), digital cable, etc. The present invention is described below as being implemented using IPTV, but is not limited thereto. Accordingly, the present invention can also be implemented in any other digital television service, such as, digital cable or the like.

IPTV service is provided by a service provider, which transmits IPTV streams to IPTV client devices of the users. IPTV streams are streams of data packets which the IPTV client devices convert into video signals. The data packets in an IPTV stream can correspond to programming content. Programming content is specific content that is scheduled for delivery at a predetermined time. The delivery time for the specific content is made available publicly prior to delivery so that the viewer can elect to view the specific content at the scheduled time. For example, the schedule for regularly scheduled television programming is published before viewing so that the viewer can select which specific program he/she wants to view at the published time. Programming content can also include specific content that is delivered at a time selected by the viewer, as in video on demand. In this embodiment of programming content, although the viewing time is not prescheduled, the viewer can select specific content for viewing at a specific time.

As opposed to programming content, advertising content, while it includes specific content, is not the subject of published scheduling based on the specific content. That is, the schedule for delivery of advertising content is not made publicly available prior to delivery. Quite to the contrary, in its commercial embodiment, the effectiveness of advertising is that the schedule for delivery of specific advertising content is not made publicly available, and is hence delivered to a semi captive audience. Of course, as disclosed herein, the delivery of advertising content need not be commercially motivated. It may, for example, be motivated by a desire to satisfy the public interest, as with public notice “advertising”, or may simply be personal messages.

According to an embodiment of the present invention, data packets corresponding to the advertising content are included in an IPTV stream along with data packets corresponding to programming content. IPTV client devices may be embodied as set top boxes which transmit the video signals to a display device, such as a television to be viewed by a user. It is also possible that an IPTV client device and a display device be provided in the same device, such as an IPTV ready television.

The targeted advertising method according to the present invention can be used by businesses. For example this method can be used by a business to offer a special promotion to a specific individual, or group of individuals, to thank an individual for a purchase. The targeting advertising method can also be used by individual users. For example, individuals can send invitations, reminders of meetings, birthday greetings, etc., in the form of an advertisement on the television of targeted users. The above uses of the present invention are purely exemplary, and are not intended to limit the invention.

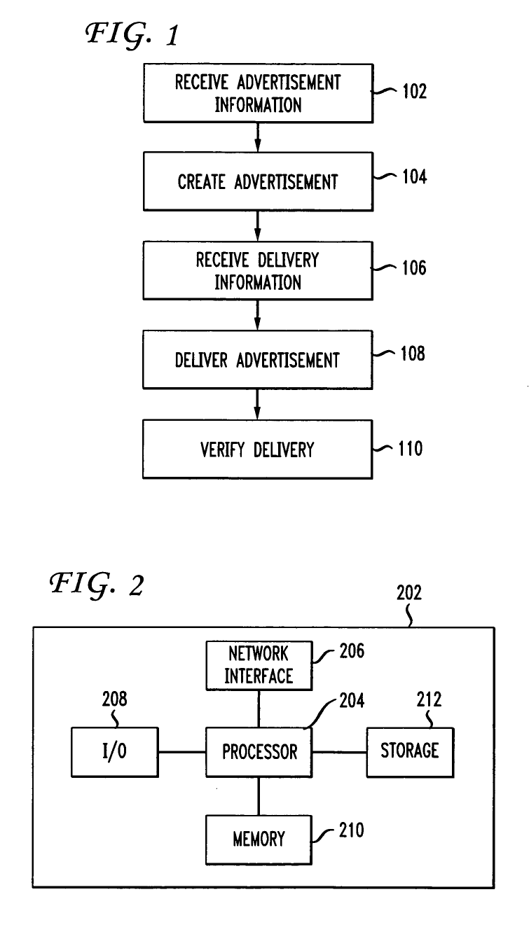

FIG. 1 illustrates a method of user to user advertising according to an embodiment of the present invention. This method can be performed by a computer system of an IPTV service provider.

At step 102, advertising information is received from a user. The advertising information is received from a user via an IP network. For example, the advertising information can be input by the user through a web interface. The web interface may be displayed on a dedicated IPTV channel. It is also possible that the web interface be accessible through a web browser on a personal computer, or the like. Accordingly, when the user wishes to create and/or send an advertisement to another user or to a group of users, the user accesses the web interface via the dedicated IPTV channel or a web browser. In an embodiment of the present invention, when the user accesses the web interface, the user must be authenticated. For example, the user may be required to enter a user ID and password.

Advertising information refers to information which defines the format and characteristics of the advertisement that the user wishes to create. The web interface may offer one or more menus of advertisement characteristics. For example, a menu corresponding to a type of advertisement (i.e., text or video) and a menu corresponding to the duration of the advertisement can be displayed by the web browser to allow the user to set these characteristics. The user can also be offered a plurality of pre-designed advertisements that act as templates for the user's advertisement. These templates can be modified using stored or uploaded graphics, audio and video in order to customize the advertisement to the targeted user or group. The web interface can also include text, graphics, audio, and video technology to allow the user to design an original advertisement. The advertising information received from the user may also be video content uploaded by the user using the web interface. This video content can be used as a portion of the advertisement or the entire advertisement.

At step 104, the advertisement is created using the advertising information received at step 102. The web interface can offer the option of previewing the advertisement to the user. If a template is selected, the template is combined with the settings specified by the user and any additional graphics, audio, or video to create the user's advertisement, which is stored in the computer system of the service provider. If a template is not selected, the advertisement designed or uploaded by the user using the web interface is stored on the computer system as the user's advertisement.

At step 106, delivery information is received from the user. The delivery information is received from the user via an IP network, such as through the web interface. The delivery information refers to settings for delivering the advertisement, as well as at least one target user to whom the advertisement is to be delivered. The capability for addressing individual set top boxes is present in IPTV networks, and is being implemented in digital cable networks. The present invention exposes the set top box addresses to all users. Thereby, the target users may be chosen from among the pool of all IPTV subscribers. The target users may be specified by giving the name and address of the user. The interface can include a mechanism for confirming that the selected target users are indeed service subscribers.

The web interface can include various menus corresponding to various delivery settings. For example, the web interface can include a menu for setting an approximate time to deliver the advertisement. This menu can include an “immediately” setting to deliver the advertisement immediately. The web interface may also include menus to specify multiple delivery (i.e., how many times the user wants the advertisement to be delivered) and to request recipient verification.

The web interface can also include a directory of users to allow the user to select one or more target users. It is possible for the web interface to have an address book function to conveniently store a private list of frequently targeted users. The received delivery information, including the delivery time and the targeted users, is stored on the computer system of the service provided along with the advertisement.

At step 108, the advertisement is delivered to the targeted users according to the specified delivery options. For example, at the delivery time input by the user through the web interface, the advertisement stored on the computer system is transmitted to the targeted users. The advertisement can be sent at the first commercial break after the delivery time while the targeted user's TV is turned on, or immediately the next time a targeted user turns on the TV. The advertisement is transmitted as part of the IPTV stream being streamed to a targeted user.

The advertisement can be delivered in the IPTV stream of a targeted user in a variety of ways. In one embodiment, the service provider has a dedicated slot in streamed programming content corresponding to a certain commercial (i.e., the first commercial of every commercial break) for personalized advertisements. In this case, the service provider streams targeted advertisements to targeted users in this slot, and streams a default commercial to users who are not targeted for a personalized advertisement. It is possible that a targeted user be alerted that a targeted advertisement is being delivered so that targeted user does not leave or switch channels during the commercial break.

In another embodiment, the targeted advertisements are played on a dedicated IPTV channel, and a targeted user is notified when a targeted message is delivered by a pop-up window or a scrolling message on the screen. The user can then switch to the dedicated IPTV channel to view the targeted advertisement. It is also possible that if the targeted user has a digital video recorder (DVR), the regular programming content could be automatically diverted to the DVR so that a targeted advertisement can be delivered immediately.

It is also possible that a message identifying the user who created the advertisement is added to the beginning or end of the advertisement. This can be implemented as scrolling text, a pop up window, or the like. Accordingly, a targeted user can determine the importance of the advertisement based on who created the advertisement.

In an embodiment of the present invention, the user who creates the advertisement must pay a fee before the advertisement is delivered. For example, the user can pay the fee via the web interface using a credit card. The fee for the targeted advertisement may alternatively be included on a monthly bill of the user.

At step 110, the delivery of the advertisement can be verified. If the user who creates the add requests recipient verification, the advertisement can require a verification input from the targeted user in order to end the advertisement. For example, the targeted user may be required to enter a specified key on a remote control to verify that the advertisement has been viewed. If targeted advertisements are played on a dedicated IPTV channel, the act of a targeted user switching to the dedicated IPTV channel can be considered verification.

In an embodiment of the present invention, the targeted advertisement may offer a menu to allow the targeted user to respond to the sender of the targeted advertisement via the IP network. For example, a menu can be displayed at the end of an advertisement with choices that are selectable using a remote control. The choices can include creating an advertisement to send back to the sender, initiating a Voice over Internet Protocol (VoIP) call to the sender, or emailing the sender. In this embodiment, a response using one of the menu choices acts as verification that the advertisement has been viewed. The menu choices can also include a standardized response, such as for an invitation. The viewer, for example, may choose between two options such as “will attend” and “will not aftend”. The choice selected by each targeted user is returned to the sender's account, and may be viewed, for example, on the same web interface that was used to create the advertisement.

The targeted advertising method according to the present invention can be implemented as a computer program executed by computer system of a digital television programming delivery service provider. For example, the method may be implemented on a computer using well known computer processors, memory units, storage devices, computer software, and other components. A high level block diagram of such a computer is illustrated in FIG. 2. Computer 202 contains a processor 204 which controls the overall operation of the computer 202 by executing computer program instructions which define such operation. The computer program instructions may be stored in a storage device 212 (e.g., magnetic disk) and loaded into memory 210 when execution of the computer program instructions is desired. Thus, the targeted advertising method can be defined by the computer program instructions stored in the memory 210 and/or storage 212 and the method will be controlled by the processor 204 executing the computer program instructions. Storage 212 is also used to store the advertising content and the delivery information received from the user. The computer 202 also includes one or more network interfaces 206 for communicating with other devices via a network. For example, the one or more network interfaces 206 can communicate with IPTV client devices via an IP network. The computer 202 also includes input/output 208 which represents devices which allow for user interaction with the computer 202 (e.g., display, keyboard, mouse, speakers, buttons, etc.). One skilled in the art will recognize that an implementation of an actual computer will contain other components as well, and that FIG. 2 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving from a first user, via an Internet Protocol (IP) network, content and delivery information corresponding to at least one targeted user; and
delivering said content in a digital data stream, as advertising content, to said at least one targeted user in accordance with said delivery information.

2. The method of claim 1, wherein said delivering step comprises:
delivering said digital data stream including said advertising content over said IP network.

3. The method of claim 1, wherein said delivering step comprises:
delivering said advertising content as part of an IPTV stream to an IPTV client device associated with said at least one targeted user.

4. The method of claim 1, wherein said delivering step comprises:
delivering said advertising content as part of a digital cable data stream to a digital cable receiver associated with said at least one targeted user.

5. The method of claim 1, wherein said receiving step comprises:
providing one or more advertisement templates;
receiving a selection signal from said first user corresponding to one of the one or more advertisement templates;
receiving information from said first user corresponding to customization options of the selected one of one or more advertisement templates.

6. The method of claim 1, wherein said content comprises video content which is ready be delivered as advertising content to said at least one targeted user when said video content is received.

7. The method of claim 1, wherein said delivery information comprises identification information corresponding to said at least one targeted user.

8. The method of claim 7, wherein said delivery information further comprises at least one of a delivery time and a delivery frequency.

9. The method of claim 1, wherein said delivering step comprises:
transmitting said advertising content along with programming content in said digital data stream such that said advertising content is played during a commercial break in said programming content.

10. The method of claim 1, wherein said delivering step comprises:
transmitting said advertising content in said digital data stream such that said advertising content is played on a dedicated television channel.

11. The method of claim 1, further comprising:
requesting verification of delivery of said advertising content.

12. The method of claim 1, further comprising:
delivering a response to said advertising content to said first user via said IP network.

13. The method of claim 1, wherein said digital data stream comprises addressable packets.

14. A method, comprising:
receiving advertisement information and delivery information from a first digital television delivery service client device;
creating an advertisement based on said advertisement information;
delivering said advertisement, as advertising content, to a second digital television delivery service client device based on said delivery information.

15. The method of claim 14, wherein the first and second digital television delivery service client devices comprise first and second IPTV client devices.

16. The method of claim 14, wherein the first and second digital television delivery service client devices comprise first and second digital cable client devices.

17. The method of claim 14, wherein said delivering step comprises:
delivering said advertisement along with programming content in one of an IPTV stream and a digital cable data stream.

18. The method of claim 14, further comprising:
displaying a web interface at said first digital television delivery service client device; and
receiving user input corresponding to said advertisement information and said delivery information via said web interface.

19. The method of claim 14, wherein said creating step comprises:
loading an advertisement template;
adjusting the advertisement template based on said advertisement information; and
storing the adjusted advertisement template.

20. The method of claim 14, wherein said delivering step comprises:
playing said advertisement during a commercial break in television programming.

21. The method of claim 14, wherein said delivering step comprises:
delivering said advertisement to a dedicated channel; and
notifying a user of said second digital television delivery service client device of delivery of said advertisement to said dedicated channel.

22. The method of claim 14, further comprising:
receiving a verification signal corresponding to delivery of said advertisement from said second digital television delivery service client device; and
transmitting said verification signal to said first digital television delivery service client device.

23. The method of claim 14, further comprising:
displaying options for responding to delivery of said advertisement at said second digital television delivery service client device; and
responding to said first digital television delivery service client device based on a selected one of the response options at said second digital television delivery service client device.

24. An apparatus, comprising:
means for receiving, via an IP network, content and delivery information corresponding to at least one targeted user; and
means for delivering said content in a digital data stream as advertising content to said at least one targeted user.

25. The apparatus of claim 24, further comprising:
means for storing said content and said delivery information.

26. The apparatus of claim 24, wherein said means for receiving comprises:
means for receiving text, graphic, audio, and video content.
